(19) United States
(12) Patent Application Publication
(10) Pub. No.: US 2003/0178151 A1
(43) Pub. Date: Sep. 25, 2003

(54) Cartridge type bead seater apparatus and method of using thereof

(76) Inventors: William B. Ritchie, Concord, NH (US); Robert Murphy, Concord, NH (US); Norman Demers, Manchester, NH (US)

Correspondence Address: William B. Ritchie, 43 Jackson Street, Concord, NH, 03301, US

(21) Appl. No.: 10/339,373

(22) Filed: Jan. 9, 2003

Related U.S. Application Data
(60) Provisional application No. 60/348,954, filed on Jan. 14, 2002.

(51) Int. Cl. B60C 25/132

(52) U.S. Cl. 157/1.17

(57) ABSTRACT

A method and apparatus for seating the bead of a tubeless tire onto a rim of a wheel. Also included is a cartridge and a bead seater kit. The bead seater apparatus includes a barrel with a nozzle. The apparatus is further provided with a tab which is associated with the barrel. The tab forms part of a rim safety mechanism, which places the apparatus in a ready to fire position when the tab is pressed against the rim of a tire thus placing the nozzle in the proper orientation between the rim of the wheel and the bead of the tire. With the safety released, the trigger is free to be pulled, which causes a firing pin to hit the primer of the cartridge chambered in the firing chamber of the apparatus. The propellant is then ignited wherein the resulting gas is substantially instantaneously released through the barrel and out of the nozzle between the rim and the tire. This, in turn, causes the tire to be at least partially inflated resulting in the bead of the tire to engage against the rim of the wheel, thus seating the tire. The apparatus does not chamber standard ammunition since the cartridge is either substantially shorter than standard ammunition or uses a caliber than is not used with conventional firearms. The cartridge is preferably a center fired shot gun shell having a hull with a primer. The cartridge is filled with an ignitable propellant but does not have any projectiles. The kit includes the bead seater apparatus, and at least one cartridge, and a carrying case. In some embodiments, the case is a hard case.

### FIELD OF THE INVENTION

The present invention relates to a cartridge type beat seater apparatus for bead seating a tubeless tire onto a rim of a wheel, and a method of using thereof.

### BACKGROUND OF THE INVENTION

While tubeless tires provide significant advantages over the tube-type, it is extremely difficult to seat the bead of the tire on the rim. This difficulty creates a special problem when trying to change a tire on the road where it is far from the customary equipment used to seat the tire.

One solution to the problem had been the introduction of ether inside the tire, which was then ignited. The resulting explosion often was sufficient to seat the tire. Of course, determining the precise amount of ether necessary to seat the tire without potential injury to the operator was next to impossible. Therefore, this method was quickly abandoned and has been declared illegal by U.S. Department of Transportation. The use of ether to seat the bead of truck tires is subject to the imposition of very substantial fines due to the inherent danger. A number of people have been killed or severely injured by using this method.

A class of such tools, which are best described as mechanical, although they may include some pneumatic elements, rely on the use of flexible straps or segmented hoops which squeeze along the circumference of the tire and thereby force the bead upward toward the bead seating surface. These mechanical devices are not adaptable to being configured portable and require a substantial amount of time in the preparation of the equipment prior to the inflation process. Also, more difficult truck tires to seat are not able to be seated with such devices.

Another class of such tools, which are best described as pneumatic but may feature non-pneumatic elements as well, utilize a source of compressed air to impart momentum to the bead and inject air into the tire, thereby initiating a progressive bead seating process. While these devices are an improvement over the above-described methods and apparatus, the use of a valve to release a stored supply of compressed air adversely affects the rise time of the pulse of air, thereby limiting the effectiveness of the device.

U.S. Pat. No. 3,866,654 issued to Duquesne, discloses a device for inflating tubeless tires that utilize a single source of compressed air which directly supplies an injection nozzle and a valve for controlling the air flow. The Duquesne device requires the tire to be inflated in a fixed location, where the supply of compressed air is located. This apparatus cannot be used to seat the bead of tubeless tire on the road. Also, the distance from compressor to injection nozzle is relatively long and the use of a mechanical valve located in the path affects the energy of the compressed air that is used in the bead seating process.

U.S. Pat. No. 5,072,764, issued to Ochoa, discloses a bead seating apparatus that utilizes a hand operated valve, preferably a ball-type valve to release a charge of air from a storage tank. The valve is located in a conduit which is in the path that the charge of air must travel to the tire. Since it takes time for the ball valve to be moved from the fully closed to the fully opened position, the rise time of the pulse of air is substantially retarded, thus reducing the effectiveness of the apparatus. Also, this device features a discharge end without a nozzle that is fashioned from the conduit which introduces additional resistance into the system.

An improvement on the Ochoa device was a bead seating apparatus manufactured by the Bead Seater Corporation. That device featured a tank, a ball-type valve and a conduit as disclosed by Ochoa. However, the Bead Seater apparatus provided a fan-shaped nozzle having a radius that was dimensioned to correspond to the rim of the tire. While the nozzle improved performance over the Ochoa device, that device was still limited by the use of the ball-type valve and the conduit.

U.S. Pat. No. 5,456,302 by Demers discloses a method and apparatus for bead seating a tubeless tire onto a rim. Two separate reservoirs are provided with an inflation reservoir bring at a slightly lower pressure than a charging reservoir. Both reservoirs are filled at the same time via a pressure differential valve. A push button causes the pressure to change slightly in the changing reservoir. A quick release valve, sensing the slight pressure change, substantially instantaneously releases the air in the charging reservoir. The release of air permits a piston to slide thus substantially instantaneously releasing the air in the inflation reservoir which is channeled to a nozzle which seats the bead of the tire on the rim.

The Demers apparatus requires an inflation reservoir, which, in the preferred embodiment is a pressure vessel having a capacity of at least 1500 cubic inches. This vessel is large and, therefore, is inconvenient to carry in a truck for use when emergency road side assistance is needed. Additionally, because of the requirement that the vessel must have the capability to store air at a pressure of at least 125 lb/in, the vessel must, in accordance with U.S. Federal Regulations, have a hard metal casing. Due to the rough treatment typically experienced in such an environment, the metal casing will end up dented or even punctured which ultimately limits the life span of the apparatus.

A portable bead seating apparatus that eliminates the need for a conduit with a valve or other releasing mechanism to produce a pulse of air having a substantially fast pressure rise time and that does not require the use of an inflation reservoir vessel, that is compact, therefore easily carried in a truck for use in an emergency, is not found in the prior art.

### SUMMARY OF THE INVENTION

It is an aspect of the present invention to provide a bead seating apparatus that ignites a propellant which results a substantially instantaneous pulse of gas to cause the tire to be seated on the rim.

It is an aspect of the present invention to provide a bead seating apparatus that utilized a propellant that can be ignited which will then provide the substantially instantaneous pulse of gas.

Another aspect of the invention is to provide a propellant encased within a cartridge that can be used to discharge gas produced by igniting a propellant into a predetermined region to thus at least partially inflate an at least partially enclosed structure.

Still another aspect of the invention is to provide a bead seating apparatus that uses black gun powder or smokeless gun powder or some combination thereof as the propellant.

It is another aspect of the present invention to provide a bead seating apparatus that is adaptable to a wide range of truck sizes and manufacturers, including those having the most difficult tire beads to seat.

It is still another aspect of the invention to provide a gas generating apparatus to at least partially inflate tires such as used on trucks, tractors, automobiles, golf carts, wheel barrows, and trailers of any type.

Another aspect of the invention is to provide a gas generating apparatus to a structure that must be inflated rapidly due to emergency conditions, such as life rafts, life preservers, emergency shelters, and the like.

It is another aspect of the present invention to provide a bead seating apparatus that is portable and easily stowable.

It is another aspect of the present invention to provide a bead seating apparatus that does not require the use of a bulky pressure vessel.

It is another aspect of the present invention to provide a bead seating apparatus that cannot be used to discharge standard ammunition due to a unique chamber dimensions used to accommodate the cartridge containing the inflating propellant.

Still another aspect of the invention is to provide a tire bead seating cartridge that is very similar to standard firearm ammunition such that it can be manufactured using conventional methods and machinery but has at least one dimension that is unique.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a cross-sectional view of the bead seating tool with the nozzle omitted in accordance with the invention.

FIG. 2 is a top view of the nozzle.

FIG. 3 is a front view of the nozzle.

FIG. 4 is a right side view of the nozzle.

FIG. 5 is an isometric view of bead seater apparatus.

FIG. 6 is a side view of the invention in position to seat the bead of a tire on the rim 60 of a wheel.

FIG. 7 is detailed cross-sectional view of a cartridge that has been loaded in the firing chamber of the tool in accordance with the invention.

### DETAILED DESCRIPTION OF THE INVENTION

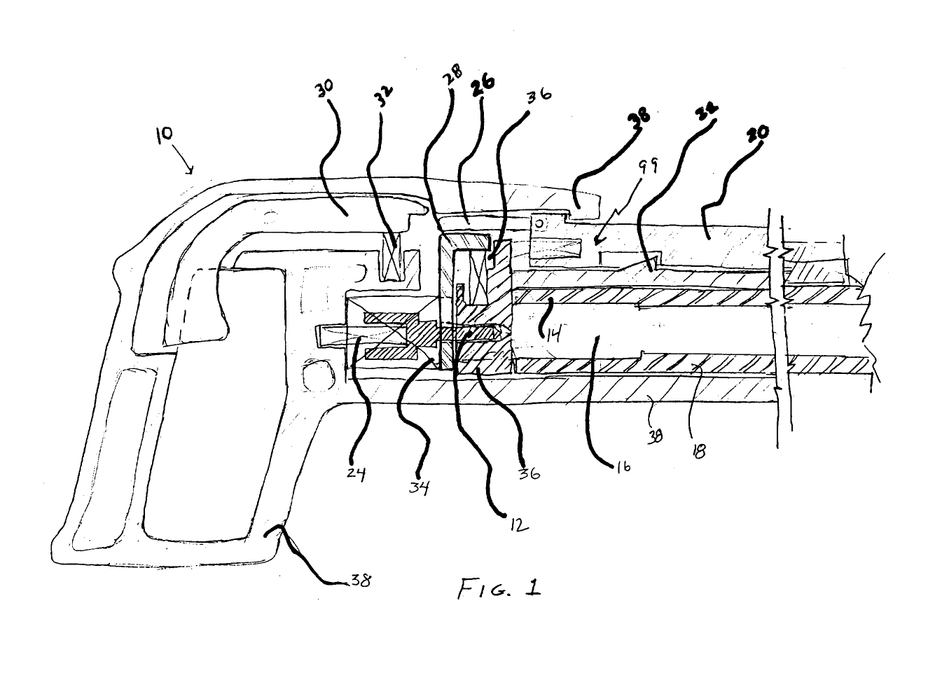

Referring first to FIG. 1, the preferred embodiment of the bead seater apparatus 10 is shown with the nozzle omitted. The embodiment shown preferably has very similar internally workings of a typical single-shot shotgun such as a Stevens Model 94 series. See. e.g., Firearms Disassembled with Exploded Views, Karns and Traister, Stoeger Publishing Company, 1995, ISBN: 0-88317-180-5. In this model, a snap is activated to unlock the barrel from the standing breech wherein the barrel is pivoted downward so that firing chamber opening is accessible. A round is inserted into the firing chamber and then the barrel is reattached to the breech. After the round has been fired, the snap is again activated. When the barrel is pivoted away from the breech, a spring activated extractor ejects the spent cartridge. While this type of mechanism is preferred due to the simplicity of manufacture and the resultant low cost, other cartridge firing mechanisms well known in the firearm arts, such as multi-shot pump action or slide action devices, also well known in the art could also be used equally as well provided the mechanism is modified in accordance with the teachings provided herein.

In that this type of mechanism such as the breech snap lock, extractor, trigger safety, etc. are well known in the art and fully documented in readily available texts such as referenced above, only those parts of the invention which differ from a typical firearm will be shown and described.

As shown in FIG. 1, the external appearance of the invention resembles a nail setting tools such as sold under the trademark RAMSET. As noted above, the bead seater apparatus 10 has a firing pin 12 mechanism similar to a typical shot gun, however, the bead seater apparatus 10 chamber 14 is designed such that the chamber 14 is dimensioned so that a standard round of ammunition having the same caliber as the propellant cartridge 70 cannot be chambered in the bead seater apparatus 10. Rather, the chamber 14 is dimensioned to only chamber a specially dimensioned cartridge 70 (shown in detail in FIG. 7) that is described below.

The apparatus 10 has a trigger 30, which, if the safety is released, (described below) compresses the trigger return spring 32, the firing pin spring 24, and the breech spring 34. This compression of springs causes the firing pin 12 to be pulled away from the barrel 18, and to the back of the breech 36. Cartridge 70 is chambered in the chamber opening 16 in the chamber 14. The firing pin 12 then hits the primer 72 of cartridge 70, causing the ignited propellant to proceed through the barrel 18, and out through the nozzle 50.

The housing 38 of the apparatus 10 is made from preferably made from steel, however, other materials capable of withstanding the pressures and forces expected and meeting Federal Regulations could also be used. The trigger 30, trigger return spring 32, firing pin spring 24, breech spring 34, firing pin 12, chamber and other parts of the apparatus are made from materials well known in the art of firearms and tools using propellant loads such as found in nail setting apparatus.

In the preferred embodiment, the apparatus 10 is preferable less than two feet long, at least in a stowed position. The size and the weight of the apparatus 10 enable apparatus 10 to be highly portable and stowable. If it desired to substantially reduce recoil when the tool is discharged as well as keep the operator further away from the nozzle of the tool, the barrel and corresponding tab safety mechanism could be made in one or more parts and then screwed together upon use. Thus, an extension could be added to the rear of housing 38 in the same manner as a stock is fitted to a rifle or shot gun so that much of the recoil is absorbed by the operator's shoulder. Further, barrel 18 and the associated parts could be lengthened as well, thus making apparatus appear more “rifle-like” in appearance. In this manner, the overall length might be substantial greater than two feet but will still stow easily due the take-down feature of the apparatus.

Because the apparatus 10 is not bulky or heavy, an average sized user can easily seat a tire using the apparatus. Additionally, the apparatus 10 fits easily into a truck drivers compartment, without taking up much space. However, in alternate embodiments, the apparatus 10 could be any length, or weight, but include the mechanism and parts, as described and illustrated herein.

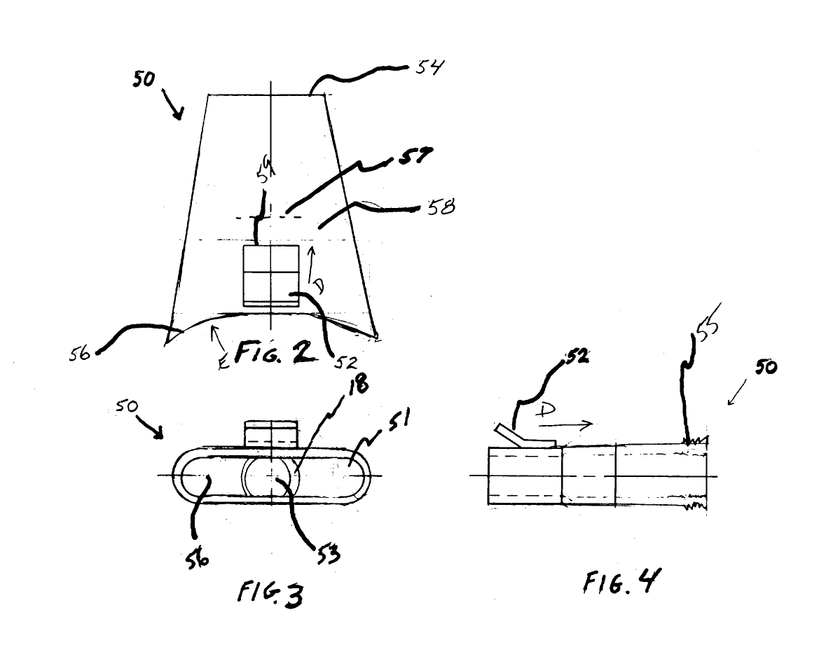

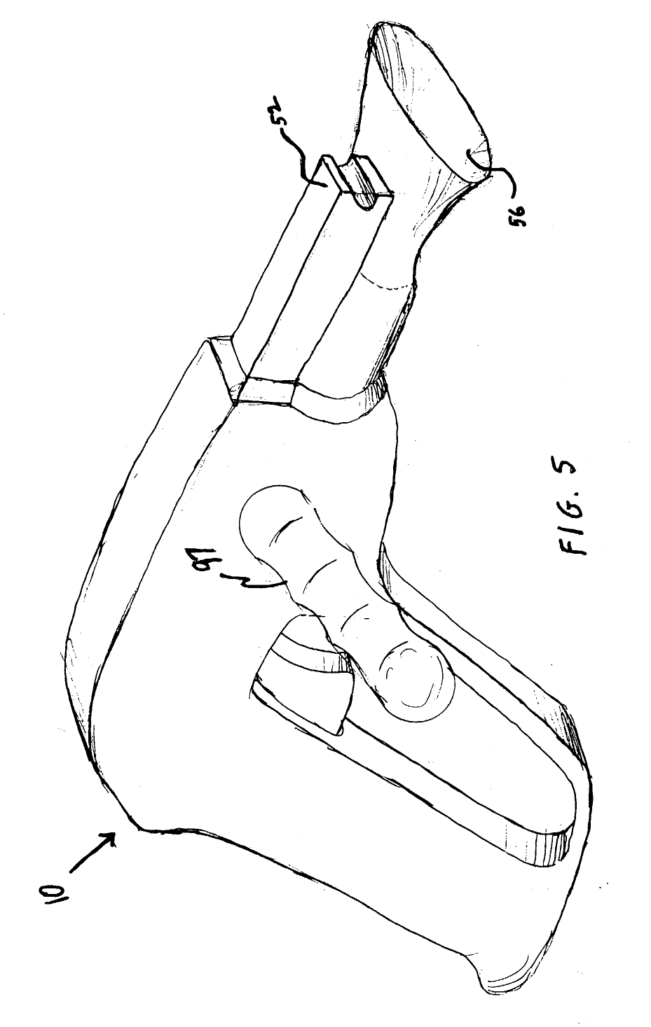

The preferred embodiment of the nozzle 50 is illustrated in FIGS. 2-4. Nozzle 50 has dimensions wherein the opening 56 is substantial greater than the cross-sectional area of bore 53 of the barrel 18. In this manner, the resistance of nozzle 50 will be substantial less than that of the barrel bore and thus will not impede the gaseous discharge from substantially instantaneously entering the tire in order to seat the bead.

The back 54 of the nozzle 50 is connected to the barrel of the apparatus preferably by threads 55 being threaded into the muzzle of barrel 18, thus being firmly attached in the same manner as a choke that is screwed in to the muzzle of a shot gun barrel.

In the preferred embodiment, nozzle 50 has a tapering shape, from back 54 to front 56, with the front end 56 of the nozzle 50 being substantially rectangular with rounded corners as shown. It is also preferable that front 56 of nozzle 50 have an arc E that approximates the arc of the rim 60 of the tire so that the gaseous discharge is directed smoothly into the space between bead of the tire and the rim.

The precise shape and dimensions of nozzle 50 is not critical provided that the opening 51 has a greater cross-sectional area greater than or substantially equal to the cross-sectional area of the bore of the barrel.

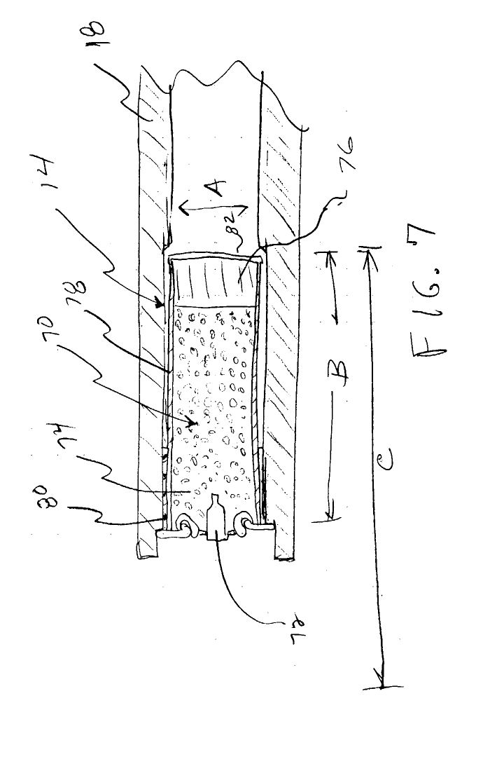

Positioning tab 52 is shown in the “safe” position on top 58 of nozzle 50. Note that tab 52 is dimensioned to engage the rim 60 of the wheel on which the tire is to be seated (see FIG. 6). Note that to place tab 52 in the “firing” position, tab 52 must be able to slide backwards in direction D so that the rear end 59 of tab 52 reaches line 57. Consequently, tab 52 is either not physically attached to nozzle 50 or is instead slidably attached so that tab 52 can be moved rearward. In this manner, invention 10 cannot be discharged unless the tool is engage against the rim 60 of a wheel and pushed forwarded so that tab 52 slides rearward, thus releasing the “safety” to permit firing. This is discussed in further detail below.

This particular safety arrangement is preferable when the invention is used to seat the bead of a tire. However, when the invention is utilized for other applications, the safety feature will be adapted accordingly. For example, if the invention was used to at least partially inflate a life raft, cartridge 50 and receiver assembly 99 would be attached to life raft in such a manner that cartridge 50 could not discharge unless receiver assembly 99 was properly positioned.

Further, a trigger safety (not shown), well-known in the art and irrespective of the application, could also be added to provide additional security if desired.

The shape of the tab 52 is illustrated. The tab 52 is designed to guide the user to place the nozzle opening 34 in the correct position in order for the bead seater apparatus to function to seat the bead of a tire. As found with nozzle 50, leading edge 81 may also feature an arc corresponding to arc E to make tab 52 engage positively with the rim 60 of the wheel.

Referring back to FIG. 1, as noted above, the bead seater apparatus 10 is equipped with at least one safety mechanism. The safety mechanism prevents the bead seater apparatus 10 from firing unless the apparatus is pushed down against the rim of a wheel. The safety mechanism is a combination of both a barrel and a rim component. In practice, the safety mechanism works as follows. The rim safety arm 20 which is connected to tab 52 presses against rim 83 of the wheel 95 (as shown in FIG. 6), which engages tooth 22 causing both the rim safety arm 20 and firing pin 12 to advance deeper into the housing cavity. As a result, the firing pin spring 24 is compressed, and the rim safety spacer 26 and sear 28 are positioned under the trigger 30. Pulling the trigger 30, causes the trigger return spring 32 and the sear spring 36 to be compressed, and forces the rim safety spacer 26 and sear 28 downward. This allows the firing pin 12 to advance and strike the cartridge 70, which is located in the chamber opening 16. Once the firing pin 12 strikes the cartridge 70, primer 72 ignites and causes propellant 74 inside the cartridge 70 to ignite, causing the expanding gas to be discharged through the barrel 18, and into the space between the rim and the tire. This substantially instantaneously release of gas into the interior of the tire causes the bead of the tire to jump against the rim, which seats the tire.

Additionally, the safety mechanism will not be released if only the barrel 18 is pressed down. Because of the tooth 22, which can only be displaced when the rim safety 20 is pushed down, the apparatus 10 will only fire when the tab 52 located on the nozzle is pressed against the rim of a tire.

It must be noted that this is only one of many possible mechanisms, all of which are well known in the art could also be used. The critical relationships are as follows: tab 52 must be pressed firmly against the rim in order for the apparatus to fire, once the tab is engaged firmly against the rim, the nozzle must be positioned properly between the rim of the wheel and the bead of the tire and, finally, the nozzle 50 and tab 52 must freely be able to move relative to one another. Another option is to have breach 36 fixed within housing 38. A hammer which could only be cocked by the action arm 20 being slid backwards and the trigger could not be released unless the arm 20 was moved to its full rearward position and the hammer was fully cocked would be prevent unsafe discharge. Still another option would be to permit the barrel to slide backwards while arm 20 is fixed. This arrangement would drive the barrel against the breach and slide both backwards so that the firing pin would be compressed and a sear mechanism would allow the trigger to be pulled once the barrel is moved to its fully rearward position. As will be clear to those of ordinary skill in the art, various permutations and combinations are possible as long as the key relationships are maintained and all such variations prevent the apparatus from being discharged unless the tool is firmly engaged against the rim of the wheel can be utilized.

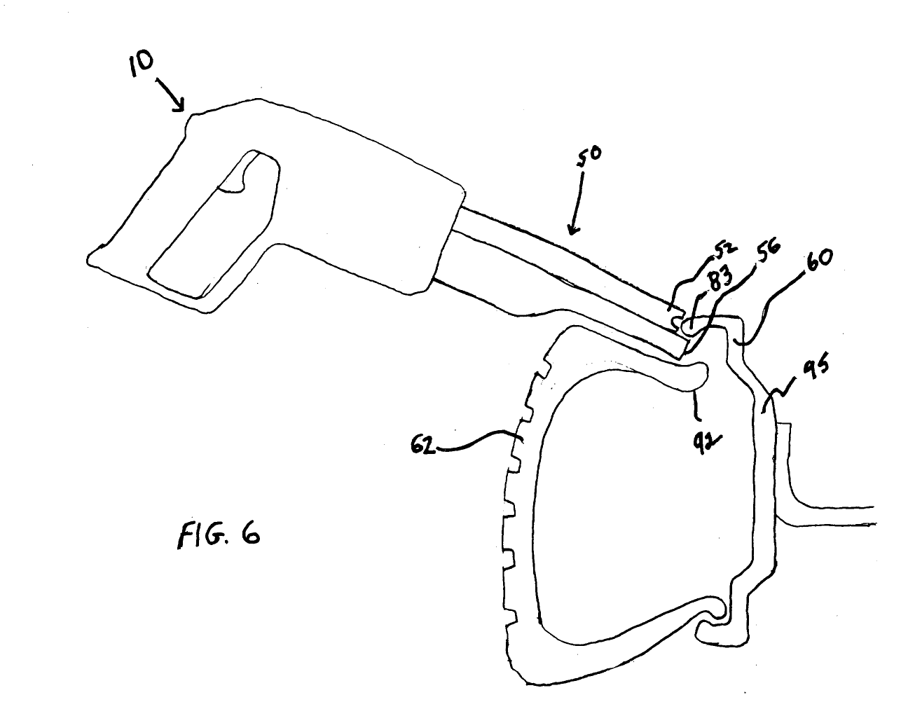

Referring next to FIG. 5, the preferred embodiment of the apparatus is shown. The apparatus is constructed primarily of metal but plastic parts can be used for the components which are not subjected to high pressures or temperatures. An optional handle 97 can be included so that the tool can be firmly held with both hands. As shown, handle 97 is position on the right side of the tool which would be preferable for a left-handed operator. Preferably, handle 97 would be designed so that fastened to either side of the tool so that the tool would be ambidextrous.

In practice, the apparatus works to seat the bead of a tubeless tire, as shown in FIG. 6. The apparatus 10 is pressed against the rim 60 of the tire 62. This is accomplished by the tab 52 located on the nozzle 50 pressing against the rim 83 of wheel 60. The nozzle opening 56 fits between the rim 60 and the tire 62. The tab 52 pressing against the rim 60 releases the rim safety, as described above. This in turn allows the apparatus to discharge, which produces a substantially instantaneous release of a gas impulse into the cavity of the tire, causing the bead 92 to jump up against the rim 60 and seats the tire 62.

As shown in FIG. 7, the bead seater apparatus 10 uses a specially designed cartridge 70 to produce a discharge of gas provided by the ignited propellant sufficient to seat the tire 62. The inventors have found by using a modified standard 12 gauge single-shot shotgun, New England Firearms, Pardner, Model SBI, fitted with a nozzle, and loaded with a 12 gauge black powder blank, manufactured by Winchester, that a sufficient volume of gas was provided to easily seat the bead of a typical 11.00/22.5 truck tire. This tire, which is recognized as being one that is especially difficult to seat, had a 15 inch C-clamp attached to the tire with each side of the jacks positioned on opposing side walls of the tire. Thus, the tire was flattened in a manner that would occur when a tire is stacked in a pile of eight tires and that tire is at or near the bottom of the pile. This, of course, made the tire even more difficult to seat the bead. A CHEETAH, manufactured by Tire Equipment Service Corporation, filled with air to a pressure of 80 psi was unable to seat the tire. However, the invention easily accomplished this task.

Other propellants such a CLEAR SHOT, a black powder substitute made by Goex Manufacturing, Inc. as well as smokeless powders were also found to successfully seat the bead of the test tire far more effectively than prior art devices.

Referring now to FIG. 7, the preferred cartridge 70 for use in seating the bead of tires is shown. Cartridge 70 is provided with hull 78 which is dimensioned such that it will not chamber into a shotgun, rifle, or other firing apparatus commonly known and found in the art. While hull 70 is typically plastic or paper, a “cartridge-less” load that has recently considered by the military (similar to the bags of propellant used to fire the large diameter guns on a naval battleship) could also be utilized. The necessary dimensioning differences to prevent projectile loaded cartridges from being fired in the apparatus can be accomplished either by selecting a caliber (diameter of the cartridge) that is not used in firearms or selecting a shorter cartridge length or a combination of the two. For example, if a 12 gauge sized cartridge is selected, then length C must be substantially less than 2¾ inches which is the standard length of 12 gauge shot gun ammunition. Correspondingly, firing chamber 14 must be dimensioned accordingly. The preferred cartridge 70 is constructed similar to standard ammunition except with dimensions modified as noted above and does not have a projectile loaded therein. Thus, a plastic or paper hull 78 is attached to brass base 80 which has a center opening in which primer 72 is inserted. A predetermined amount of propellant 74 is loaded into the cartridge 70. The amount of propellant 74 is dependent upon task required. A 12 gauge shot gun blank loaded with approximately 179 grains of black powder compressed with a fiber wad 76 crimped with a star-shaped crimp 82 was found to successfully seat the bead of a typical truck tire. A fiber wad is preferable rather than plastic wads since it is desired that little residue remains once the wad 76 exits the barrel as this residue will remain in the tire. Fiber wad 76 is made from materials used for such wadding and is well known in the art.

If a black powder substitute is used, it is measured by volume rather than by weight when attempting to match black powder. An equal volume of CLEAR SHOT FFg would weigh approximately 163 grains. However, the inventors have found that the use of CLEAR SHOT FFg propellant seats the tire even more effectively and even inflates the tire to approximately psi without the need for a supplemental air hose attached to valve stem of the tire. Substitution of smokeless propellant for the CLEAR SHOT FFg require that the volume and/or weight of the propellant selected be adjusted accordingly, using techniques well known in the art, in order to provide an even more powerful similar result. For example, using a fast burning smokeless propellant similar to a WINCHESTER type AA, only 60-90 grains of propellant are required to seat the bead of the test tire referenced herein. Once the volume of the apparatus that is to be at least partially inflated is determined, the cartridge gauge, hull shape, primer, propellant, wad, compression can be correspondingly selected using techniques well known in the art.

The apparatus, together with the cartridge, form a bead seater kit. In the preferred embodiment, the kit additionally includes multiple cartridges, from 1 to 10, and is packed into a hard shell case. The kit can be stored easily in a trunk, or inside the driver compartment of a truck.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A bead seater apparatus for seating the bead of a tubeless tire onto a rim of a wheel, said apparatus comprising:
a receiver assembly having a trigger and a firing chamber with at least one dimension substantially different than the firing chambers of firearms designed to chamber standard ammunition;
a barrel having a bore with a cross-sectional area, said barrel having a breach end and a nozzle end, wherein the breach end of said barrel is connected to said receiver;
a nozzle having an opening that has a cross-sectional area that is at least as great as the cross-sectional area of the bore of said barrel, and wherein said nozzle is connected to nozzle end of said barrel;
a safety having an “on” and an “off” position such that when said safety in is the “on” position, the trigger is unable to discharge a cartridge loaded in the firing chamber of said receiver assembly and such that to place said safety in the “off” position requires said nozzle to be positioned between the bead of the tire and the rim of the wheel so that the cartridge loaded in the firing chamber of said receiver assembly can be discharged, thus causing the bead of the tire to seated on the rim of the wheel.

2. A cartridge for seating the bead of a tubeless tire such the length of said cartridge is substantially less than the length of a standard cartridge of the same caliber.

3. The cartridge of claim 2 wherein said cartridge is a shot gun shell.

4. The cartridge of claim 3 wherein the shot gun shell is 12 gauge.

5. The cartridge of claim 1 further comprising at least one propellant selected from the group consisting of black powder, a black powder substitute, and smokeless powder.

6. The cartridge of claim 1 further comprising a fiber wad that substantially disintegrates after exiting said cartridge after said cartridge is fired such that little residue remains.

7. A bead seater kit to seat the bead of a tubeless tire onto the rim of a wheel,
said kit comprising:
a bead seater apparatus for seating the bead of a tubeless tire onto a rim of
a wheel, said apparatus comprising:
a receiver assembly having a trigger and a firing chamber with at least one dimension substantially different than the firing chambers of firearms designed to chamber standard ammunition;
a barrel having a bore with a cross-sectional area, said barrel having a breach end and a nozzle end, wherein the breach end of said barrel is connected to said receiver;
a nozzle having an opening that has a cross-sectional area that is at least as great as the cross-sectional area of the bore of said barrel, and wherein said nozzle is connected to nozzle end of said barrel;
a safety having an “on” and an “off” position such that when said safety in is the “on” position, the trigger is unable to discharge a cartridge loaded in the firing chamber of said receiver assembly and such that to place said safety in the “off” position requires said nozzle to be positioned between the bead of the tire and the rim of the wheel so that the cartridge loaded in the firing chamber of said receiver assembly can be discharged, thus causing the bead of the tire to seated on the rim of the wheel; and
at least one cartridge for seating the bead of a tubeless tire such the length of said cartridge is substantially less than the length of a standard cartridge of the same caliber wherein said cartridge is dimensioned to fit within the firing chamber of said receiver assembly.

8. The kit claimed in claim 7, wherein said kit further comprising a carrying case, wherein said case accommodates said cartridge and said apparatus.

9. The kit claimed in claim 8, wherein said case is a hard case, whereby said hard case protects the contents of said kit.

10. A method of at least partially inflating an at least partially closed structure thereby defining an opening to said at least partially closed structure, said method comprising the steps of:
confining a predetermined amount of propellant within a cartridge;
positioning said cartridge in a predetermined orientation relative to the opening of said at least partially closed structure;
preventing the discharge of said propellant when cartridge is not within the predetermined orientation;
firing said cartridge so that the propellant is ignited thereby producing a volume of gas directed into structure, wherein said at least partially closed structure is at least partially inflated with the volume of gas.

11. The method of claim 11 wherein said propellant is selected from the group consisting of black powder, black powder substitute, and smokeless powder.

12. The method of claim 10 wherein said at least partially closed structure is a tubeless tire.

13. The method of claim 10 wherein the opening is the space between the bead of the tire and a rim of a wheel that said tire is to be mounted thereon.

14. The method of claim 10 wherein said confining step of the predetermined amount of propellant is accomplished by placing said propellant in a center fired shot gun shell, wherein said center fired shot gun shell differs from a standard shot gun shell by the absence of all projectiles and has a length that is substantially shorter than a standard shot gun shell of the same caliber.
